(19) United States
(12) Patent Application Publication
(10) Pub. No.: US 2005/0016981 A1
(43) Pub. Date: Jan. 27, 2005

(54) Personal blind heat containment apparatus and method therefor

(76) Inventor: George Irvin, Griffin, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/626,227

(22) Filed: Jul. 24, 2003

(51) Int. Cl. H05B 3/34

(52) U.S. Cl. 219/211; 219/549

(57) ABSTRACT

A personal blind heat containment apparatus, and method therefor, comprising a temperature controlled environment for outdoorsmen comprising a fleece outer garment, which covers the full head and body with the exception of an eye opening, a suitable means for sitting on, and a non-asphyxiating heating means.

### TECHNICAL FIELD

The present invention relates generally to an apparatus and method for providing a personal environment to outdoorsmen, and more particularly to an apparatus and method for providing a warm enclosure for hunters while they await game.

### BACKGROUND OF THE INVENTION

Although various devices and methods to provide a warm environment are known, all are disadvantageous when compared to the present invention.

For instance, some devices require a connection to an alternating or direct current supply, and are thus unsuitable for use in remote environments. Still other devices lack a supply of heat and are unsuitable for cold weather environments.

Also known are devices that utilize as body warmers having a seat, having a heat source and wherein an envelope surrounds the user's body. Although such devices may be designed for outdoor spectators and/or hunters, such devices are disadvantageous as they typically require a heat shield to protect the user from the heat source and hoop rings to keep the bottom of the device open, thus to prevent contact with the heat source. Additionally, most such devices do not cover the user's head, but usually terminate at the user's shoulders and, thus, leave the head and upper torso unprotected. Moreover, such devices generally require that the chair be externally located, if utilized, thereby inadequately facilitating ease of use. Such known devices further lack a means for securing to the ground to complete the confinement of heated air, and also lack a means for securing of the user via a cable and harness to a point above.

Also desired is a system for securing a person to a structure, such as a tree or post. Known systems do not provide for fastening a garment around the tree, a post or a chair, only the attachment of safety wires thereto, and are further disadvantageous wherein they lacks heater means.

While some or all of the above-referenced devices may be utilized for providing some form of heating to an outdoorsman, they lack facility to provide adequate warmth and the ability to cover the head and face, and are overly complicated. Therefore, it is readily apparent that there is a need for a personal blind heat containment apparatus and method that overcomes the aforementioned disadvantages by providing weather protection via a warm enclosure covering the entire body and head.

### BRIEF SUMMARY OF THE INVENTION

The present invention arose from a need to provide a warm environment for outdoorsmen in remote areas, wherein the device is readily portable and wherein the device permits a hunter to observe his prey while maintaining himself and his weapon at the ready in the warm environment.

Briefly described, in a preferred embodiment, the present invention overcomes the above-mentioned disadvantages and meets the recognized need for such a device by providing a method and apparatus for maintaining an individual within a warm environment, yet still allows the individual to hunt or perform other outdoor activities that require the individual to remain in a stationary position for an extended period of time. The device and method may also be utilized to provide warmth to individuals recuperating from exposure to cold weather conditions and their effects.

According to its major aspects and broadly stated, the present invention in its preferred embodiment is an overgarment, preferably constructed from fleece, wherein the overgarment preferably covers the head, but still provides an opening for the eyes. The overgarment preferably extends down to the ground, where it can be staked to provide an expansive area suitable for covering not only the lower torso and extremities of an individual, but also a chair and a non-asphyxiating heating device.

More specifically, the present invention is a fleece covering having a zippered portion in the front thereof for permitting entry therethrough. The fleece is preferably positioned over a chair, thereby allowing the user to maintain a comfortable position in which to await and observe game. A heating device is preferably positioned under, or adjacent to, the chair for providing heat to the user. The fleece covering is further adapted to be secured to the ground, floor, and/or to a rear anchor, such as a tree post, via use of a second zipper portion in the rear of the fleece covering. Although the garment preferably covers the arms of the user, openings in the front of the fleece covering permit insertion of hands therethrough to the inside environment. The device has sufficient space inside to permit a hunter to have his weapon at the ready within the garment, if desired, requiring only raising of the weapon upon sighting suitable game. The user can readily exit the garment via the zippered front should he desire to operate his weapon from a position external of the garment.

A feature and advantage of the present invention is its ability to be utilized as a tree blind or ground blind by a hunter.

A feature and advantage of the present invention is its ability to allow nearly full coverage of the head without asphyxiating the wearer.

A further feature and advantage of the present invention is its suitability for cold weather environments, particularly severe cold weather environments.

A feature and advantage of the present invention is its portability.

A further feature and advantage of the present invention is its ease of manufacture and low cost of production.

A further feature and advantage of the present invention is that it can be utilized to provide medical treatment by raising and maintaining the body temperature of individuals who have suffered from overexposure to a cold environment.

A feature and advantage of the present invention is that it permits a hunter to have his weapon at the ready in a warm, secure environment.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1 is a front perspective view of a personal blind heat containment apparatus according to a preferred embodiment of the present invention.

FIG. 2 is a rear perspective view of a personal blind heat containment apparatus according to a preferred embodiment of the present invention.

FIG. 3 is a perspective view of a personal blind heat containment apparatus of the present invention shown with user having weapon ready.

### DETAILED DESCRIPTION OF THE PREFERRED AND ALTERNATIVE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

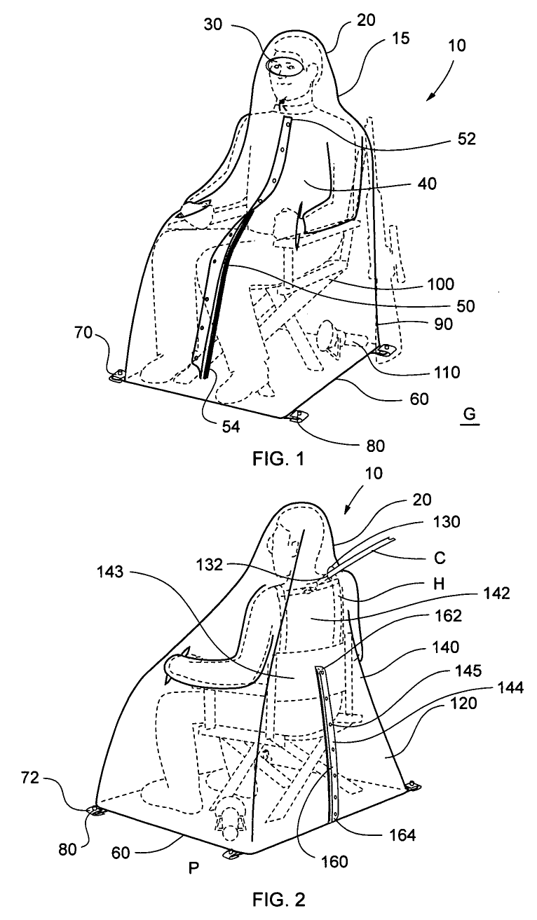

Referring now to FIG. 1, apparatus 10 is preferably made of a fleece-type material and preferably has head portion 20 with eye opening 30 formed therethrough. Front torso portion 40 preferably has zipper 50 therein, wherein zipper 50 preferably extends from zipper top 52 and lies preferably proximate head portion 20 down the full length of front torso portion 40, and preferably to zipper bottom 54. Zipper bottom 54 preferably lies proximate to base perimeter 60, wherein base perimeter 60 is preferably secured to ground G by inserting stakes 70 preferably through securing grommets 80. Base perimeter 60 is preferably secured in a rectangular, nearly square, fashion, thereby preferably providing a tent-like enclosure via base 90 of apparatus 10.

Preferably located within base 90 of apparatus 10 is chair 100 for permitting a user to be seated while apparatus 10 is in use. Alternatively, a user may stand while utilizing apparatus 10. Heater 110 is preferably located underneath chair 100. Heater 110 is preferably a non-asphyxiating heater, such as, for exemplary purposes only, a BLACKCAT™ portable catalytic heater, as is available from the COLEMAN™ Company of Wichita, Kans. The external surface of Heater 110 is further preferably of the type that maintains a relatively low surface temperature, so as to prevent burn injury upon momentarily touching/contacting same.

Preferably, the warm environment of apparatus 10 forms a shell around outdoorsmen, and particularly hunters, and is utilized in shielding themselves from extremely cold ambient temperatures.

Apparatus 10 is further preferably utilized as a hunting blind that allows a hunter to remain warm while waiting for game to appear. Apparatus 10 further preferably permits easy accessibility and is readily transportable.

Referring now to FIG. 2, illustrated therein is apparatus 10 from a rear perspective. Rear portion 120 of apparatus 10 preferably has opening 130 preferably located below head portion 20 and proximate to top 142 of rear torso portion 140. Opening 130 is preferably sized for passage therethrough of cable C suitable for utilization in tethering the wearer of apparatus 10 via harness H. When apparatus 10 is utilized in a tree blind or raised area, cable C preferably passes through reinforcing grommet 132 and secures above the user. Base perimeter 60 is secured by clips 72 through grommets 80. Zipper 160 is preferably located below opening 130, preferably extending from zipper top 162, wherein zipper top 162 preferably lies proximate top 144 of base portion 120 to zipper bottom 164, and wherein zipper bottom 164 preferably lies proximate to base perimeter 60. Zipper 160 is preferably selectively utilized to allow apparatus 10 to be secured over an object, such as a post, a tree stump or a fixed chair.

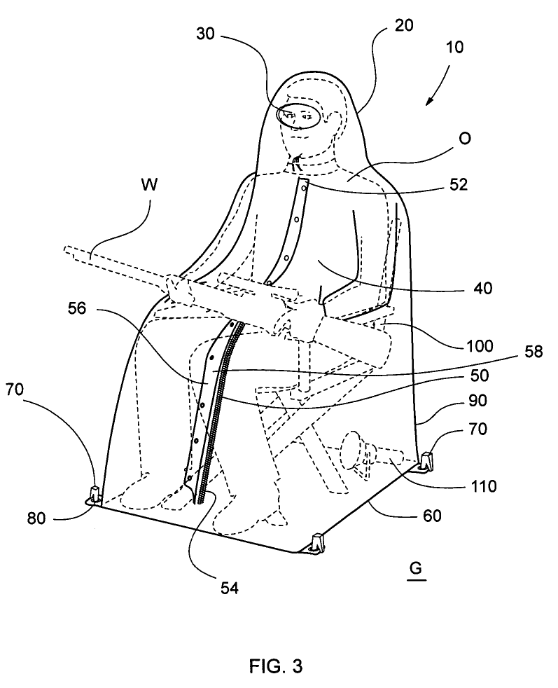

Referring now to FIG. 3, apparatus 10 is shown in use by outdoorsman O. Outdoorsman O preferably installs apparatus 10 over chair 100, securing apparatus 10 over and around chair 100 by use of zipper 160 (see FIG. 2). Once zipper 160 is closed, zipper 160 is covered by closing snaps 142, thereby securing flap 144 and providing a heat-tight environment barrier at the rear of apparatus 10. Outdoorsman O then preferably enters apparatus 10, secures or closes zipper 50, and thereafter preferably closes snaps 56 to secure flap 58. Once fully enclosed with apparatus 10, Outdoorsman O may maintain weapon W in a ready condition, held either inside apparatus 10 externally thereof. Outdoorsman O may further selectively stand or sit on chair 100. Heater 110 preferably provides warmth to the air contained within apparatus 10, thereby providing a contained and warmed environment for outdoorsman O.

It is envisioned in an alternate embodiment that apparatus 10 may be made from a rain-proof material.

It is further contemplated in an alternate embodiment that apparatus 10 may be made from any insulating material such as, for exemplary purposes only, GORE-TEXT, as is available from W. L. Gore & Associates, Inc. of Newark, Del.

It is contemplated in an additional embodiment that apparatus 10 may include a means for securing base 90 to the floor of a hunting or tree blind.

It is envisioned in an alternate embodiment that eye opening 30 may include an eye covering, such as, for exemplary purposes only, goggles, visors, mesh screen, or the like.

It is further envisioned in an alternate embodiment that a cooling environment may be created by the present invention, wherein a small cooling device could be incorporated, thereby cooling the inside of the fleece overgarment.

It is further contemplated in an alternate embodiment that apparatus 10 could be enlarged to accommodate more than one user.

In an alternative embodiment, it is envisioned that an exhaust of heater 110 may exit apparatus 10, or alternately that heater 110 may be partially enclosed by apparatus 10.

Having thus described exemplary embodiments of the present invention, it should be noted by those skilled in the art that the within disclosures are exemplary only, and that various other alternatives, adaptations, and modifications may be made within the scope of the present invention. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A temperature controlled environment comprising:
at least one garment for covering a wearer's head and body; and
at least one non-asphyxiating heating means comprising a catalytic heater, wherein said at least one garment completely encloses said at least one non-asphyxiating heating means.

2. The temperature controlled environment of claim 1, wherein said at least one garment covers the wearer's head, including the wearer's mouth and nose, and wherein the wearer breathes the air within the envelope of said at least one garment.

3. The temperature controlled environment of claim 1, further comprising means for seating, wherein said at least one garment at least partially encloses said means for sitting on.

4. The temperature controlled environment of claim 1, wherein said garment comprises:
at least one head portion;
at least one torso portion having front wall and back wall;
at least one arm portion; and
at least one base portion having a front wall, side walls and back wall.

5. The temperature controlled environment of claim 4, further comprising at least one zippered-entry frontally disposed on said at least one torso portion and said at least one base portion.

6. The temperature controlled environment of claim 4, wherein said at least one torso portion has at least one opening formed therein for hand insertion.

7. The temperature controlled environment of claim 4, wherein said at least one torso portion has at least one opening formed therein for extention of a support cable therethrough.

8. The temperature controlled environment of claim 4, wherein said at least one head portion at least partially covers the head of a wearer, and wherein said at least one head portion further includes at least one eye opening.

9. (cancelled)

10. The temperature controlled environment of claim 3, wherein said seating means comprises a chair.

11. The temperature controlled environment of claim 10, wherein said chair is collapsible.

12. The temperature controlled environment of claim 4, wherein said at least one torso portion and said at least one base portion each comprise at least one zipper extending across said at least one torso portion back wall and said at least one base portion back wall, and wherein said at least one zipper extends from approximately the middle of said at least one torso portion to approximately the bottom of said at least one base portion, whereby said temperature control environment can be secured around a fixed object.

13. The temperature controlled environment of claim 12, further comprising at least one snap flap for covering said at least one zipper, whereby a heat-tight environment is created.

14. The temperature controlled environment of claim 5, wherein said at least one zippered-entry further comprises at least one snap flap to cover said at least one zippered-entry, whereby a heat-tight environment is created.

15. The temperature controlled environment of claim 1, wherein said garment further comprises at least one securing grommet.

16. The temperature controlled environment of claim 1, further comprising means for securing said temperature controlled environment around a stationary object.

17. The temperature controlled environment of claim 1, further comprising means for tethering, whereby said temperature control environment may be tethered to an object, and whereby said temperature control environment is prevented from a reduction of altitude by said means for tethering.

18. A method for creating a warm environment comprising the steps of:
a. providing an outer shell garment;
b. providing means for heating; and
c. providing an entryway, wherein a user may at least partially enclose himself in said warm environment.

19. The method for creating a warm environment of claim 18, wherein said heating means is a non-asphyxiating heating means.

20. A hunting blind comprising:
floor;
at least one shell overgarment covering wearer's head and body, including wearer's mouth and nose;
means for sitting; and
means for heating, said heating means being non-asphyxiating.

21. The temperature controlled environment of claim 8, wherein said at least one eye opening further comprises an eye covering selected from the group consisting of, goggles, visors, mesh screens, and combinations thereof.
